(19) United States
(12) Patent Application Publication
(10) Pub. No.: US 2026/0009535 A1
(43) Pub. Date: Jan. 8, 2026

(54) APPARATUS AND METHOD FOR METHANE COMBUSTION OF RUMINANT ANIMALS

(71) Applicant: Nick Reyntjens, Lierde (BG)

(72) Inventor: Nick Reyntjens, Lierde (BG)

(21) Appl. No.: 19/231,490

(22) Filed: Jun. 8, 2025

(30) Foreign Application Priority Data
Jul. 2, 2024 (PT) 20242006262971

(51) Int. Cl. F23G 7/06; C01B 32/50; F23G 5/44; F23G 5/50

(52) U.S. Cl. CPC F23G 7/06; C01B 32/50; F23G 5/44; F23G 5/50; F23G 2203/60; F23G 2208/00; F23G 2209/141; F23G 2900/70

(57) ABSTRACT

An apparatus and method are provided for reducing methane emissions from ruminant animals by combusting methane gas extracted from the rumen. The system comprises a conduit configured to transport methane from the animal's rumen to a combustion module mounted externally or implanted partially or fully in a subdorsal position. The combustion module includes a pressure-activated valve, air intake, ignition system, and combustion chamber enclosed by a heat-absorbing roof structure. A control unit monitors internal gas pressure and triggers a spark ignition circuit when combustion conditions are satisfied. An upward-facing camera inhibits ignition if flammable obstructions are detected above the module. A water-filled thermal buffer integrated into the chamber roof moderates exhaust temperature, reducing wildfire risk. Power is supplied by a solar panel and rechargeable battery. The system intermittently converts methane into carbon dioxide and water vapor, significantly mitigating the greenhouse gas impact of enteric fermentation in ruminant livestock.

### CROSS REFERENCE TO RELATED APPLICATIONS

This application claims the benefit of Portuguese Patent Application No. 20242006262971, titled “Apparatus and Method for Methane Combustion of Ruminant Animals,” filed by Nick Reyntjens on Jul. 2, 2024.

### TECHNICAL FIELD

This invention generally pertains to agricultural and environmental technologies, specifically to methane mitigation systems for ruminant livestock involving gas capture and conversion, and may intersect with fields such as animal husbandry, climate change mitigation, and gas processing apparatus design.

### BACKGROUND

Ruminant animals, such as cows, sheep, and goats, may produce significant quantities of methane during their digestive process, primarily through enteric fermentation in the rumen. Methane is a potent greenhouse gas, and its emission from livestock could contribute substantially to global atmospheric warming. Efforts to mitigate such emissions have included dietary modifications, microbial feed additives, and selective breeding. However, these methods may have limited effectiveness, variable outcomes, or economic and practical constraints.

Methane emitted by ruminants is typically released into the atmosphere through eructation, and capturing this gas before it escapes could offer a means of reducing its environmental impact. One potential approach might involve intercepting the methane directly from the rumen and converting it into a less harmful compound, such as carbon dioxide, which although still a greenhouse gas, may have significantly lower global warming potential than methane.

Systems that could combust methane extracted from livestock might offer a practical alternative to biochemical or dietary interventions. However, challenges may arise in ensuring safe ignition, managing thermal output, integrating the device with a live animal, and providing sufficient power for autonomous field operation. Further considerations might include ensuring that the combustion process occurs only under safe conditions, avoiding the risk of wildfire or harm to the animal, and maintaining system durability in agricultural environments.

Accordingly, there could be a need for a compact, self-contained, and animal-mounted apparatus capable of collecting methane gas from the rumen and intermittently converting it into carbon dioxide through a controlled combustion process. The present invention is intended to address these needs.

### SUMMARY

The present invention relates to a system that may reduce methane emissions from ruminant animals by capturing and combusting methane gas produced in the rumen. Methane, a potent greenhouse gas, is typically expelled through enteric fermentation, and the proposed system could serve to convert it into less harmful carbon dioxide and water vapor via controlled combustion.

The system may comprise a methane collection assembly adapted to extract gas from the rumen through a conduit or flexible tube. The collected methane could be routed to a combustion module, which may be mounted externally on the animal or alternatively embedded partially or fully in a subdorsal position. This combustion module may include a pressure-activated valve, an air intake, a combustion chamber, and an ignition system. A control unit could coordinate the opening of the valve and the triggering of a spark ignition based on internal pressure readings. For safety, an upward-facing camera or optical sensor may detect overhead obstructions such as vegetation, and may be used to suppress ignition events when needed.

To address thermal management, the combustion chamber could be enclosed by a roof structure that may contain a water-filled thermal buffer reservoir. This buffer might absorb peak heat from combustion, thereby moderating exhaust temperature and reducing the likelihood of environmental ignition. Exhaust gases could exit through an outlet located around the perimeter of the chamber roof.

The system may be powered by a photovoltaic panel coupled with a rechargeable battery, allowing it to operate autonomously under varying environmental conditions. The electronic and mechanical components could be integrated within a compact frame, which may be customized for specific animal sizes or species. Operation may be performed intermittently, and gas flow could be managed passively via internal pressure or actively using a pump.

In certain embodiments, the system could include wireless telemetry or data logging features for remote monitoring or health diagnostics. The overall design may be modular and scalable, making it adaptable for use across a range of agricultural settings.

### BRIEF DESCRIPTION OF DRAWINGS

FIG. 1 illustrates a ruminant animal (1), such as a cow, equipped with a methane combustion module (2) mounted externally. The module is secured using a mounting strap assembly (4), and receives methane gas via a conduit tube (3) extending from the animal's rumen. The exhaust stream (5) exits the module post-combustion.

FIG. 2A shows a perspective view of the combustion module (2), highlighting external components including the methane inlet port (201), air intake port (202), strap attachment interface (203), photovoltaic solar panel (204), and upward-facing safety camera (205).

FIG. 2B presents a side view of the combustion module (2), showing the spatial arrangement of the methane inlet port (201), air intake port (202), solar panel (204), safety camera (205), and the perimeter-based combustion gas outlet (206).

FIG. 3 provides a cutaway schematic view of the internal structure of the combustion module (2). Visible components include the methane inlet (201), gas control valve (210), air intake (202), methane dispersion nozzle (207), ignition electrode (208), internal pressure sensor (209), combustion chamber frame (211), combustion chamber roof (213), and burned gas outlet (206). The thermal buffer water reservoir (214) is positioned inside the combustion chamber roof (213) and absorbs intermittent combustion heat.

FIG. 4 is a bottom view of the structural chamber frame (211), showing internal electronic and flow control components mounted within the combustion module. Visible features include the methane inlet pipe (201), internal pressure sensor (209), gas control valve (210), electronic control unit (221), rechargeable battery (220), and spark generation circuit (222).

FIG. 5 presents an exploded view of the combustion module (2), illustrating the assembly relationship between major structural and external components. Shown parts include the combustion chamber frame (211), protective side plate (212), combustion chamber roof (213), upward-facing safety camera (205), and photovoltaic solar panel (204).

### DETAILED DESCRIPTION OF ILLUSTRATIVE EMBODIMENTS

To improve clarity and avoid visual clutter, the electrical connections between the various electronic components shown in the drawings—such as the control unit, battery, ignition system, sensors, and solar panel—are not explicitly illustrated. It is understood that persons skilled in the art of electrical engineering would be capable of implementing standard wiring, connectors, or printed circuit board (PCB) layouts to establish the necessary power and signal interconnections between these components.

Similarly, while the drawings depict the integration of components into a three-dimensional housing or enclosure in a basic form, the specific layout, enclosure geometry, and fastening methods may vary. Such variations may be implemented using conventional CAD-based mechanical design and assembly techniques. These variations do not depart from the scope or spirit of the invention, and the present disclosure and its claims are intended to cover all functionally equivalent configurations, forms, and construction methods that would be apparent to a person skilled in the art.

Specific features, structures, or characteristics mentioned in reference to a particular embodiment may or may not be present in other embodiments. The use of terms such as “one embodiment,” “an embodiment,” or “an illustrative embodiment” does not imply limitations or exclusivity. Additionally, references to “preferred” components or features signify their desirability in specific contexts but do not restrict their applicability to other embodiments.

It is understood that a person skilled in the art, upon reviewing this disclosure, can readily implement described features, structures, or characteristics in connection with other embodiments, whether explicitly described or not.

Listings in the form of “at least one of A, B, and C” encompass all possible combinations of A, B, and C, including individual elements and their conjunctions. The same principle applies to listings in the form of “at least one of A, B, or C” and “A, B, and/or C.” In the claims, terms like “a,” “an,” “at least one,” and “at least one portion” are not limiting to a single element unless explicitly stated.

While the drawings illustrate specific arrangements and orderings of structural or method features, these are not prescriptive. In various embodiments, such features may be arranged differently or combined, unless otherwise specified. The inclusion of a feature in a particular figure does not imply its necessity in all embodiments.

The disclosed embodiments can be implemented in hardware, firmware, software, or any combination thereof. They can also be embodied as instructions stored on machine-readable media, executed by one or more processors.

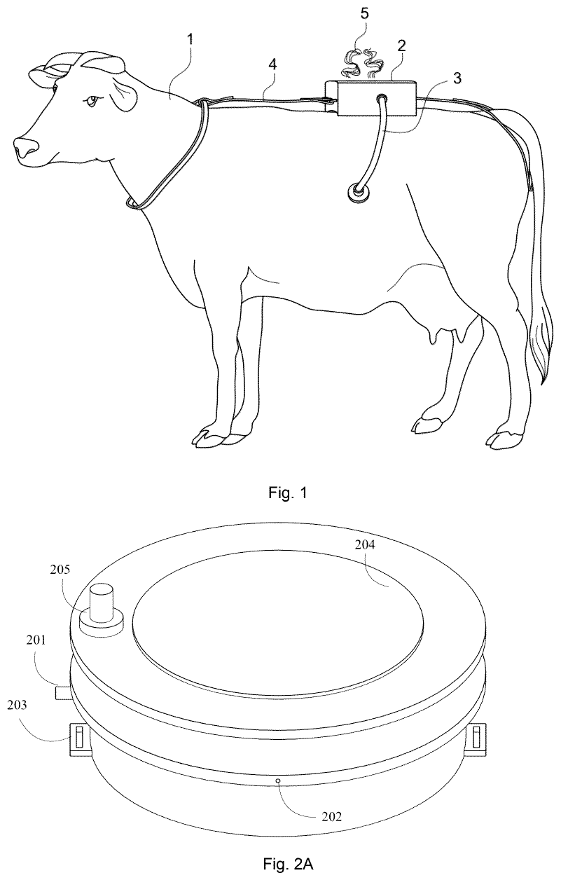

The present invention may relate to an apparatus (2) that could be used to reduce methane emissions from ruminant animals (1), such as cows, by capturing methane gas from the rumen and converting it into carbon dioxide via controlled combustion. FIGS. 1 through 5 illustrate an exemplary embodiment that may be implemented in various ways.

As shown in FIG. 1, the methane combustion module (2) may be mounted externally on the animal (1) using a mounting strap assembly (4). The strap could be positioned over the dorsal, lateral, or other suitable body surfaces and secured via a strap attachment interface (203). Methane may be delivered from the rumen via a rumen conduit tube (3), which might be surgically implanted through the rumen wall. This conduit could connect at its distal end to the methane inlet port (201) of the combustion module.

Referring now to FIGS. 2A and 2B, the combustion module (2) may comprise several key external features. A photovoltaic solar panel (204) could be mounted on the upper surface to supply electrical power to internal components. An upward-facing safety camera (205) may be positioned near the top of the housing and oriented vertically to monitor for flammable obstructions, such as tree branches, above the module. A burned gas outlet (206) might be located near the perimeter of the device to allow combustion gases to exit. Ambient air may be drawn into the system via an air intake port (202) to support combustion. These components would typically be structurally supported within a combustion chamber frame (211).

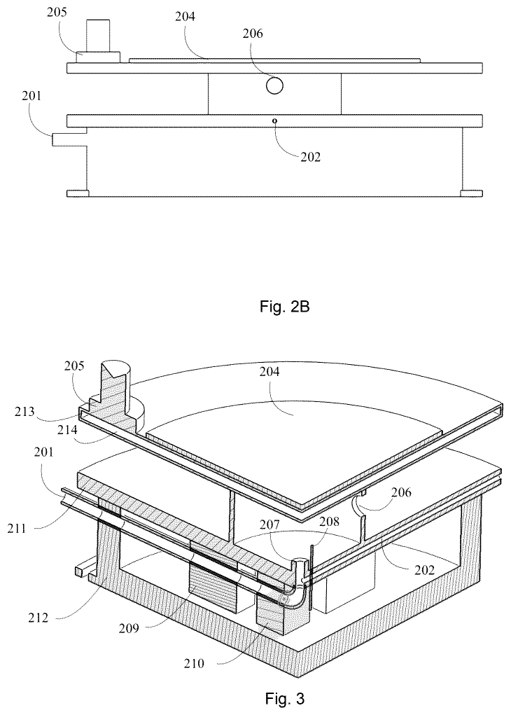

FIG. 3 shows a schematic cutaway that could represent the internal architecture of the combustion module (2). Methane may enter the system through the inlet port (201) and pass into a gas control valve (210), which might be managed by an electronic control unit (221) in response to data received from an internal pressure sensor (209). When certain activation criteria are met—possibly based on a pressure threshold or a timed schedule—the valve could open to allow methane to enter the combustion chamber via a dispersion nozzle (207). The gas could then mix with ambient air drawn through the air inlet (202). An ignition electrode (208), positioned within the combustion chamber, may be energized by a spark generation circuit (222) to ignite the methane-air mixture.

To manage heat generated during combustion, the combustion chamber might be enclosed above by a combustion chamber roof (213). This structure may be generally horizontal and disk-shaped, such that hot gases would flow along its underside before exiting. A thermal buffer water reservoir (214) could be positioned inside the chamber roof and serve to absorb intermittent heat peaks, thereby reducing exhaust temperature. This arrangement might lower the risk of fire and enable the system to sustain repeated combustion cycles without overheating.

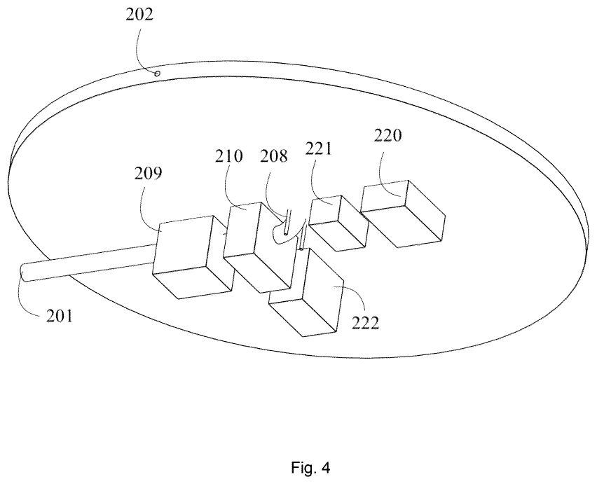

FIG. 4 provides a bottom view of the internal frame (211), showing how the electronic and flow control subsystems could be arranged. The methane inlet pipe (201) may connect directly to the gas control valve (210). Nearby components could include the pressure sensor (209), electronic control unit (221), rechargeable battery (220), and spark generation circuit (222). These subsystems might be compactly integrated to reduce volume and could be powered using energy harvested from the solar panel (204).

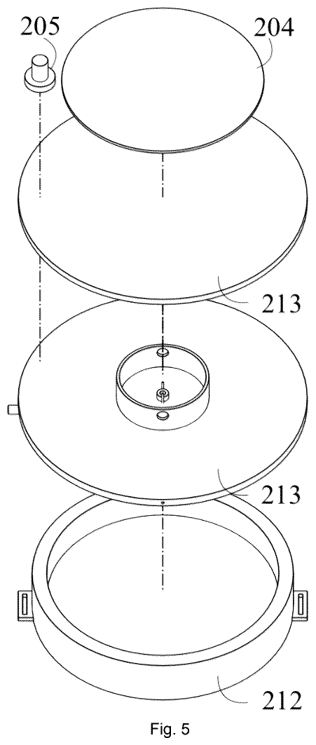

FIG. 5 presents an exploded view of the combustion module (2), illustrating how the components may be assembled. The combustion chamber frame (211) could serve as the main structural support. A protective side plate (212) might be placed between the module and the animal and could include padding or thermal insulation. The combustion chamber roof (213) and internal thermal reservoir (214) may be mounted above the chamber volume. The upward-facing safety camera (205) and solar panel (204) are shown mounted on the top surface.

In operation, the control unit (221) may synchronize the opening of the valve (210) and activation of the ignition electrode (208) based on sensor data, programmed combustion timing, and environmental safety conditions as determined by the camera (205). Under such coordinated control, methane from the rumen could be combusted and converted into carbon dioxide and water vapor, which might substantially reduce the global warming potential associated with enteric methane emissions.

The apparatus may optionally include features for wireless communication, telemetry, or health-related monitoring, and could be manufactured in modular formats adaptable to different animal sizes or farm configurations.

In one embodiment, the invention comprises an apparatus configured to reduce methane emissions from a ruminant animal by combusting methane gas extracted from the rumen. The apparatus includes a conduit adapted to transport methane gas from the rumen to a combustion module. The combustion module is mounted externally on the animal, or alternatively embedded partially or fully in a subdorsal position. The module comprises a methane inlet, an air intake, and a combustion chamber configured to receive and mix methane with ambient air to form a combustible mixture. An ignition system, including an ignition electrode and a spark generation circuit, is configured to initiate combustion of the methane-air mixture. A control unit monitors pressure in the conduit and evaluates environmental safety conditions, including overhead obstructions, to determine when ignition should occur. Combustion gases are released through an outlet located near the perimeter of a disk-shaped chamber roof. This roof incorporates an internal water-filled thermal buffer reservoir that absorbs heat from combustion and reduces exhaust temperature. A solar panel charges a rechargeable battery, which provides power to the control unit, ignition system, and sensors.

In this embodiment, the process can be described as follows: methane gas produced during enteric fermentation is collected from the rumen and transported via the conduit to the combustion module. As methane accumulates, the internal pressure is monitored. When the pressure reaches a predefined threshold—or at scheduled intervals—the control unit opens a valve to allow methane to flow into the combustion chamber. Simultaneously, ambient air enters through an air intake. The gases mix in the combustion chamber to form a combustible mixture. The control unit verifies that combustion may proceed safely, based on data from environmental sensors, including an upward-facing optical system. If safe, the ignition system is triggered, igniting the methane-air mixture and converting it into carbon dioxide and water vapor. The resulting hot gases flow along the underside of the chamber roof, transferring heat to the internal water reservoir. This moderates the temperature of the gases before they are released through the outlet. The process may repeat intermittently, depending on gas accumulation and environmental conditions.

In another embodiment, the combustion module may include a catalytic converter chamber in place of, or in addition to, a traditional combustion chamber with open flame ignition. In this configuration, the methane gas collected from the rumen is directed through a catalyst substrate-such as a metal oxide or noble metal catalyst-which facilitates the oxidation of methane at lower temperatures, eliminating the need for a spark ignition system. Ambient air is drawn in and mixed with the methane upstream of the catalyst bed. The control unit may still monitor gas pressure and environmental conditions, and could regulate gas flow into the catalyst chamber using a valve. The oxidation reaction produces carbon dioxide and water vapor as output gases, which are then released through a temperature-buffered outlet. This configuration may reduce the risk of fire ignition entirely by avoiding open flame, and could be particularly advantageous in high-risk environments or in situations where thermal management is critical. Power for system monitoring and valve control may still be provided by a solar panel and battery assembly.

In another embodiment, additional or alternative sensors may be integrated into the control system to enhance environmental safety prior to ignition. For example, a GPS module could be used to define geofenced zones where ignition is prohibited-such as barns, storage sheds, or forested areas-based on known location coordinates. In some configurations, a sonar or upward-facing proximity sensor may be used to detect overhead structures, such as barn roofs or tree canopies, with greater spatial resolution than optical methods alone. Beacon-based systems could also be employed, wherein fixed-location transmitters (RFID, Bluetooth, or other identifiers) are placed in restricted zones, and the apparatus is programmed to suppress ignition upon detecting such beacons. These sensors may operate independently or in combination, and the control unit may weigh their input to make real-time decisions about whether ignition or catalytic oxidation should proceed. This variation provides an additional safeguard against unintended combustion in enclosed or high-risk environments, and may be particularly suited to farms with mixed indoor-outdoor grazing systems.

An alternative to relying solely on a solar panel for powering the ignition and controls is to harvest the waste heat from methane combustion itself using a Peltier (thermoelectric) generator: the temperature gradient between the hot combustion chamber and the cooler external casing can drive a small voltage output, charging the onboard battery and even trickle-feeding the control electronics. This heat-to-electricity approach can make the device fully self-sufficient in settings where sunlight is limited, such as indoor barns or overcast climates. However, because many cattle graze outdoors in open pastures—where solar irradiance is abundant—a compact solar panel can often deliver more consistent, higher-power input for rapid battery recharge, especially during extended idle periods when the combustion cycle is inactive. By offering both thermoelectric and photovoltaic energy-harvesting options, the system can be tailored to diverse farm environments, ensuring reliable operation whether the herd is housed indoors or roaming under the sun.

In one embodiment, the invention may be described as a system and method for mitigating methane emissions at the source by converting enteric methane into carbon dioxide before release into the atmosphere. The system may include a gas conversion module positioned on or within the animal, preferably in proximity to the site of methane production. This module may contain a conversion mechanism—such as a catalytic bed, heated element, or electrochemical reactor—that facilitates oxidation or transformation of methane gas into less potent byproducts such as carbon dioxide and water vapor. The apparatus may be attached externally using straps or adhesives, or alternatively implanted beneath the skin in anatomical regions near the rumen. A power subsystem, which may include a solar panel, thermoelectric generator, or compact battery, may be provided to support autonomous operation. In practice, such a system could enable passive or semi-active mitigation of greenhouse gas emissions from livestock, offering a scalable approach to agricultural decarbonization without interfering with animal health or digestion. Various configurations and energy sources may be used depending on environmental conditions, regulatory requirements, and species-specific anatomical constraints.

In one embodiment, the invention may be described as an apparatus for reducing methane emissions from a ruminant animal, comprising a gas conversion module that may be configured to receive methane generated in the rumen of the animal, a mounting interface that may be adapted to attach the gas conversion module externally to the body of the animal or implant it subdermally, and a conversion mechanism that may be operable to convert methane into carbon dioxide through catalytic, thermal, chemical, or electrochemical processes.

Alternatively, the invention may be described as a method for reducing methane emissions from a ruminant animal, comprising optionally collecting methane gas produced in the animal's rumen, operatively associating a methane conversion apparatus with the animal such that the apparatus may be attached to or implanted within the animal, and converting the collected methane into carbon dioxide using a controlled conversion process conducted within the apparatus.

### ADDITIONAL TECHNICAL CONTEXT

Procedures involving long-term access to internal gas or fluid systems via implanted tubing are well established in both human and veterinary medicine. In the case of ruminant animals, rumen fistulas—surgically installed ports providing access to the rumen—are commonly used in agricultural research and education. These fistulas are maintained over extended periods with low infection rates, demonstrating that sustained gas access can be achieved without compromising animal welfare when appropriate hygiene protocols are followed.

In humans, percutaneous gastrostomy tubes, nasogastric tubes, and intestinal stomas are widely used for nutritional and clinical purposes, often remaining in place for months or years. These systems typically involve flexible conduits routed through soft tissue and secured to the body, offering a well-established precedent for safely managing long-term access to internal cavities. The engineering principles, surgical techniques, and infection control methods used in human care may be readily adapted to ruminant animals, enabling safe and stable methane extraction through an implanted conduit system.

Addressing the global motivation, methane emissions from ruminant livestock—particularly cattle—are estimated to contribute approximately 5% of total global greenhouse gas warming potential. While feed additives such as seaweed extracts have shown some ability to reduce methane production, reductions are often modest and highly variable between individual animals and farm conditions. In contrast, direct gas capture and conversion at the point of emission offers a more controlled and quantifiable mitigation pathway. The system described herein allows for such intervention without altering digestion, diet, or animal behavior.

Given the existing veterinary infrastructure for rumen access and the critical need for scalable methane mitigation strategies, the described invention offers a technically feasible and biologically compatible solution.

What is claimed is:

1. An apparatus for reducing methane emissions from a ruminant animal, comprising:
a. a conduit configured to transport methane gas from the rumen of the animal;
b. a combustion module configured to be mounted externally or subdermally on the animal, the combustion module comprising:
i. a methane inlet configured to receive methane from the conduit;
ii. an air intake configured to supply ambient air;
iii. a combustion chamber configured to mix methane and air;
iv. an ignition system comprising an ignition electrode and a spark generation circuit;
v. a combustion gas outlet;
vi. a control unit configured to monitor conditions and trigger ignition; and
vii. a power source comprising a solar panel and a rechargeable battery.

2. The apparatus of claim 1, wherein the combustion chamber includes a disk-shaped roof, and wherein the combustion gas outlet is located at the perimeter of the roof.

3. The apparatus of claim 2, further comprising a thermal buffer comprising a water reservoir positioned inside the combustion chamber roof and configured to absorb heat from the combustion process.

4. The apparatus of claim 1, wherein the control unit is configured to monitor internal methane pressure using a pressure sensor and to trigger ignition when a threshold is exceeded.

5. The apparatus of claim 1, further comprising an upward-facing optical sensor or camera configured to detect overhead flammable obstructions and suppress ignition accordingly.

6. The apparatus of claim 1, wherein the control unit is configured to disable ignition when a beacon is detected from a restricted zone transmitter.

7. The apparatus of claim 1, wherein the control unit includes a GPS module and is configured to apply geofencing logic to suppress ignition in predefined geographic zones.

8. The apparatus of claim 1, wherein the combustion module further includes a sonar or proximity sensor configured to detect solid structures above the unit.

9. The apparatus of claim 1, wherein the control unit is configured to aggregate data from multiple sensors and suppress ignition based on a safety decision model.

10. The apparatus of claim 1, wherein the combustion module further comprises a protective side plate configured to thermally and mechanically isolate the unit from the animal's body.

11. An apparatus for reducing methane emissions from a ruminant animal, comprising:
a. a conduit configured to transport methane gas from the rumen of the animal;
b. a catalytic oxidation module configured to be mounted externally or subdermally on the animal, the module comprising:
i. a methane inlet;
ii. an air intake;
iii. a catalytically active medium configured to promote the oxidation of methane into carbon dioxide and water vapor without open flame;
iv. a gas outlet for releasing oxidation products;
v. a control unit configured to regulate gas flow and safety conditions; and
vi. a solar-powered battery system configured to operate the control and sensor subsystems.

12. The apparatus of claim 11, wherein the catalyst bed comprises a metallic or metal oxide substrate supported within a heat-resistant chamber.

13. The apparatus of claim 11, wherein the control unit is configured to compare pressure sensor data and environmental safety inputs before allowing gas to pass through the catalyst bed.

14. The apparatus of claim 11, wherein the catalyst chamber includes a thermal management structure comprising a buffered heat sink or water jacket.

15. The apparatus of claim 11, wherein the apparatus includes a modular strap-based mounting assembly with detachable sensor and power units.

16. A method for reducing methane emissions from a ruminant animal, comprising:
a. extracting methane gas from the rumen through a conduit;
b. delivering the methane to a gas conversion module mounted externally or subdermally on the animal;
c. mixing the methane with ambient air within the gas conversion module;
d. converting the methane into carbon dioxide and water vapor using either a combustion-based process or a catalytic oxidation process; and
e. releasing the resulting gases into the environment through an outlet.

17. The method of claim 16, further comprising detecting overhead obstructions using an upward-facing optical or proximity sensor and suppressing combustion-based ignition when obstructions are present.

18. The method of claim 16, further comprising buffering the heat generated during combustion using a water-filled reservoir integrated into the combustion chamber roof.

19. The method of claim 16, further comprising suppressing methane flow into the gas conversion module based on data from geofencing, beacon, or proximity detection systems.
